(19) United States
(12) Patent Application Publication
(10) Pub. No.: US 2006/0200684 A1
(43) Pub. Date: Sep. 7, 2006

(54) Power mode change voltage control in computerized system

(76) Inventors: Vasudev Bibikar, Austin, TX (US); Rajith Mavila, Austin, TX (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/069,924

(22) Filed: Mar. 1, 2005

(51) Int. Cl. G06F 1/26

(52) U.S. Cl. 713/300

(57) ABSTRACT

A computerized system includes at least one digital logic circuit and a power control circuit. The power control circuit is operable to reduce the voltage of a power signal applied to the at least one digital logic circuit, operable to bring the digital logic circuit from a high power level to a low power level, and operable to increase the voltage of the power signal applied to the digital logic circuit before bringing the digital logic circuit from a low power level to a high power level.

### FIELD OF THE INVENTION

The invention relates generally to computerized system power management, and more specifically to controlling voltage as a part of power mode change in a computerized system.

### BACKGROUND

A wide variety of devices, including personal digital assistants, cellular telephones, and appliances now incorporate sophisticated processors, monitors or displays, and other elements once found only in expensive computers. Incorporation of processors has enabled cellular telephones to do more than just serve as a telephone—it is now common for such cell phones to include phone directories, digital cameras, music playback, video games, and to offer a high degree of programmability or customization to the cell phone end user or service provider. Similarly, personal digital assistants, or PDAs, commonly include software including calendar, e-mail, word processing, and other traditional computer functions.

But, while traditional computers are usually plugged in to a wall socket or outlet that provides electric power on a continuous basis, many portable devices such as cell phones and PDAs are powered by rechargeable batteries incorporated into the electronic computerized device. This limits the amount of time one can use such a portable device to the amount of time the rechargeable battery can provide adequate power to operate the device. One could simply use bigger batteries in situations where long-lasting operation was desirable, but battery size and performance is often traded off for smaller overall device size, lighter weight, and lower cost.

Engineers have addressed this issue by developing electronic devices that require less power to operate, or that can operate at reduced speed to conserve power. Such methods are also sometimes employed in other systems such as normal desktop computers and laptop computers, particularly where significant power savings can be realized. Reduced power consumption in desktop computers results in a reduction in utility bills, energy demand, and pollution, and is particularly desirable when it can be implemented across a wide number of systems without a significant reduction in performance.

It is therefore desirable that computerized devices have power management capability such that power can be conserved.

### BRIEF DESCRIPTION OF THE FIGURES

FIG. 1 is a block diagram of a computerized system employing a power controller consistent with an example embodiment of the invention.

FIG. 2 is a timing diagram, illustrating power signal voltage change in an example embodiment of the invention.

FIG. 3 is a flowchart state diagram, illustrating a way of managing power consistent with an embodiment of the invention.

FIG. 4 is a detailed block diagram of a cellular telephone employing a power controller consistent with an example embodiment of the invention.

FIG. 5 shows a power controller register used to manage the power state of a computerized system, consistent with an example embodiment of the invention.

### DETAILED DESCRIPTIONS

In the following detailed description of example embodiments of the invention, reference is made to specific examples by way of drawings and illustrations. These examples are described in sufficient detail to enable those skilled in the art to practice the invention, and serve to illustrate how the invention may be applied to various purposes or embodiments. Other embodiments of the invention exist and are within the scope of the invention, and logical, mechanical, electrical, and other changes may be made without departing from the subject or scope of the present invention. Features or limitations of various embodiments of the invention described herein, however essential to the example embodiments in which they are incorporated, do not limit the invention as a whole, and any reference to the invention, its elements, operation, and application do not limit the invention as a whole but serve only to define these example embodiments. The following detailed description does not, therefore, limit the scope of the invention, which is defined only by the appended claims.

The examples of the invention presented here serve to illustrate how power can be managed in a digital logic circuit such as a computer processor to conserve energy. In various embodiments, power is managed by reducing the voltage of a power signal applied to at least one digital logic circuit, and bringing the digital logic circuit from a high power mode into a low power mode. The low power mode is exited by increasing the voltage of the power signal applied to the digital logic circuit before bringing the digital logic circuit from a low power mode to a high power mode.

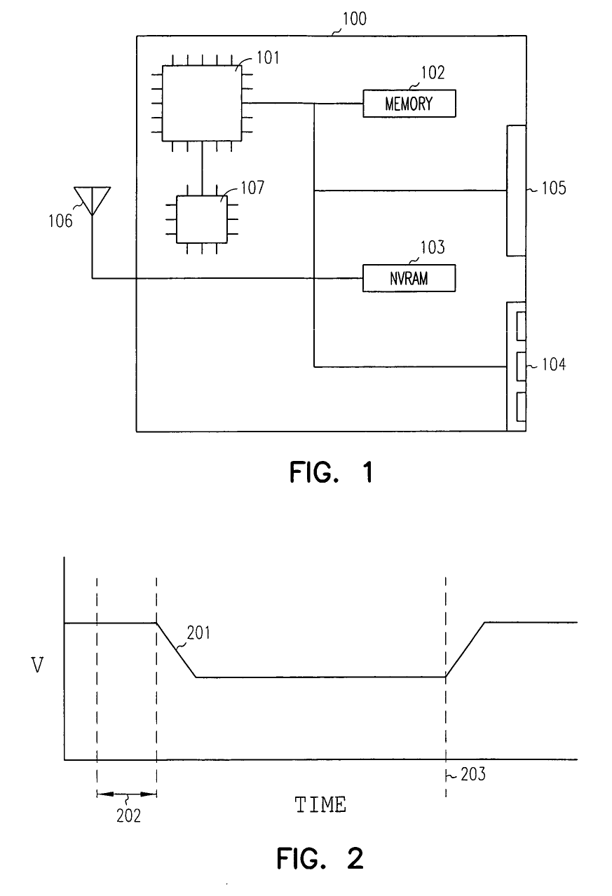

FIG. 1 illustrates a block diagram of a computerized system employing a power controller, consistent with an example embodiment of the invention. A computerized device 100 contains a computer processor 101, coupled via a bus to a memory 102. A nonvolatile random access memory 103 is also coupled to the processor and to the memory, and is in an alternate embodiment replaced with or supplemented by a hard disk drive or other nonvolatile data storage module. A keypad or keyboard 104 is coupled to the processor to provide user input, and the computerized device is operable to display information to the user via display 105.

In a further embodiment, the device 100 is a portable wireless device having an antenna 106. The processor is coupled to a power controller 107, which is operable to control a power state of at least one digital logic circuit in the processor 101. The processor is further operable to control a power supply signal voltage provided to the digital logic circuit within the processor 101.

In operation, the processor executes program instructions loaded into memory 102 from nonvolatile random access memory 103 or another nonvolatile data storage device such as a hard disk drive. The processor also works with other data, such as information provided by the user via the keyboard 104 and information conveyed to the user through display 105 or other user interfaces such as a speaker. The executing program in many circumstances is not a stream of constantly executing program instructions, but comprises bursts of program operation followed by periods of inactivity. Devices such as cellular phones and wireless personal digital assistants (PDAs) use an antenna 106 coupled to an RF module to communicate wirelessly with other devices or communications networks.

When the processor is not actively executing program instructions, part or all of the processor can be brought to a low power mode or level. In some embodiments, this occurs by reducing the frequency of the clock signal provided to processor 101, or to a portion of the digital logic circuits within the processor. Each time the clock signal provided to a processor or other digital logic circuit changes state, many transistors within the processor change state, requiring a significant expenditure of energy even when no program instructions are being executed. The fewer times per second such state changes occur, the less power the digital logic circuit consumes. Reducing the clock frequency, or stopping the clock signal altogether, can therefore result in a reduction in power consumption.

The power controller 107 is in some embodiments operable to reduce the clock frequency provided as described above, and is further operable to vary the voltage of the power signal applied to the processor. For example, the processor may be brought from a normal high voltage level of 3.3 Volts down to a lower voltage level such as 2.5 Volts or 1.5 Volts, or from another normal operating voltage to a lower voltage to further conserve power. Although the processor 101 can issue commands to the power controller 107 to reduce voltage and to shut down part or all of the logic circuits within the processor, it typically will not be able to issue a command to recover from the reduced voltage or shut down condition because part or all of the logic circuit within the processor will be inoperable until the processor is brought back to normal operating mode.

One solution to the problems this presents is for the power controller 107 to bring the processor or certain logic circuits within the processor into a low power mode by reducing voltage at or after a command to do so is received from the processor, and to return from the low power mode back to a higher power mode by receiving a trigger from an event external to the processor that causes the power controller to increase the voltage provided to the processor and to bring the processor back to a higher power state. For example, a cellular telephone that is closed and brought to an idle mode executes software that causes the processor 101 to issue a command to the power controller 107 to bring the processor to an idle mode. The power controller responds by bringing the processor from an operating voltage of 2.5 Volts to a reduced voltage of 1.3 Volts, and stops the digital logic clock signal sent to the processor. The power controller is configured to monitor remaining circuitry in the cellular phone to bring the processor out of the idle mode and back to a fully operative mode when certain hardware events occur, such as on receiving an incoming phone call, on opening the flip-phone style phone hinge, or upon the user pressing a button on the phone. These hardware events trigger the power controller's bringing the processor voltage back up to the operating voltage of 2.5 volts, and cause reconnection of the digital logic clock signal to the processor.

In another example, a personal digital assistant is rendering video via processor 101 and video display screen 105, and is displaying new video fields at a rate of 24 frames per second. After a frame is rendered, the processor enters a low power mode by reducing the voltage from 3.3 to 1.5 Volts, and reduces the clock frequency from 400 MHz to 50 MHz. The power controller is instructed to bring the processor back to a high power mode tens of milliseconds after going to a reduced power mode, so that the next video frame may be rendered. The power controller brings the voltage back from a low power level of 1.5 Volts to a high power level of 3.3 Volts, and increases the processor's clock frequency from 50 MHz to 400 MHz, bringing the processor back into its normal operating mode.

FIG. 2 is a timing diagram illustrating operation of an example embodiment of the invention. The Voltage of a power signal supplied to digital logic circuits such as those comprising part or all of a processor is shown. Voltage signal 201 varies as time proceeds left to right, as shown relative to the time and voltage axes. Before region 202 the voltage is at a normal operating level of 3.3 Volts, and the voltage is reduced in region 202 to a lower voltage of 1.5 Volts. The time period shown in 202 further illustrates one of the examples given in conjunction with FIG. 1, in which a command to reduce the power signal after a predetermined time is given at the beginning of time window 202, and the voltage is reduced after a predetermined time at the end of time window 202. The delay is in some embodiments present to enable a processor to conduct other operations or to complete execution of specific processes before it is shut down as a result of the power level command issued to the power controller. This is desirable, because the processor or certain logic circuits in the processor will usually be inoperable once the power signal powering the circuits is transitioned to a lower voltage.

At 203, a hardware event such as a timer, keyboard operation, or other signal triggers a return to a higher power mode or level, and the power signal supplied to the processor logic circuits is brought back to a normal operating voltage of 3.3 Volts. The processor is then sufficiently powered to be fully operable. In further embodiments, the clock signal provided to the processor or to certain digital logic circuits within the processor is also reduced in frequency or is suspended to reduce the number of state changes attempted within the still-powered logic circuits near the time the voltage is reduced at region 202, and is restored to the normal clock frequency near the subsequent voltage increase at 203.

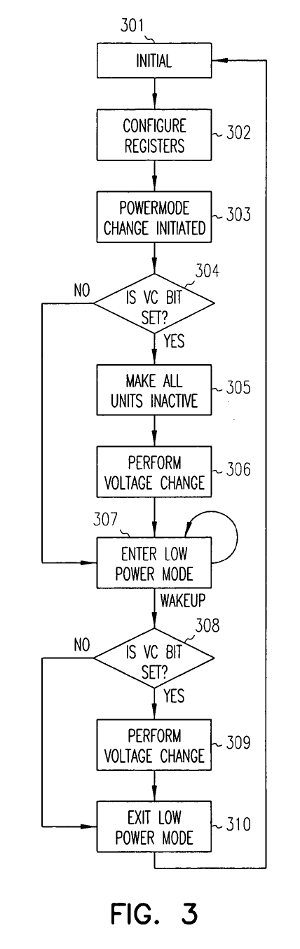

FIG. 3 is a state diagram showing a more detailed example method of managing power, consistent with an example embodiment of the invention. After the initial operating mode at 301, a program instruction, hardware event, or some other trigger causes hardware registers in the power controller to change at 302. This results in initiation of a power mode change at 303. At 304, the power controller observes the hardware registers to see if a voltage change (VC) bit is set. If the voltage change bit is set, the power controller makes all functional units in the logic circuit supplied by the power signal that is subject to the voltage change inactive at 305, and changes the power signal voltage to a lower voltage at 306. The logic circuits are maintained in a low power mode at 307 until a wakeup event triggers a power mode change, proceeding to 308.

If a power mode change is initiated but the voltage change bit is not set at 304, the process proceeds to 307 without undergoing the inactive mode and voltage change processes at 305 and 306. Return to normal operating mode also includes evaluation of the voltage change bit from the power controller registers at 308, such that the voltage change from a reduced voltage level to the normal operating voltage level from which the power signal was changed at 306 if the voltage change bit is set. Low power mode is then exited at 310, and normal operation of the logic circuits resumes.

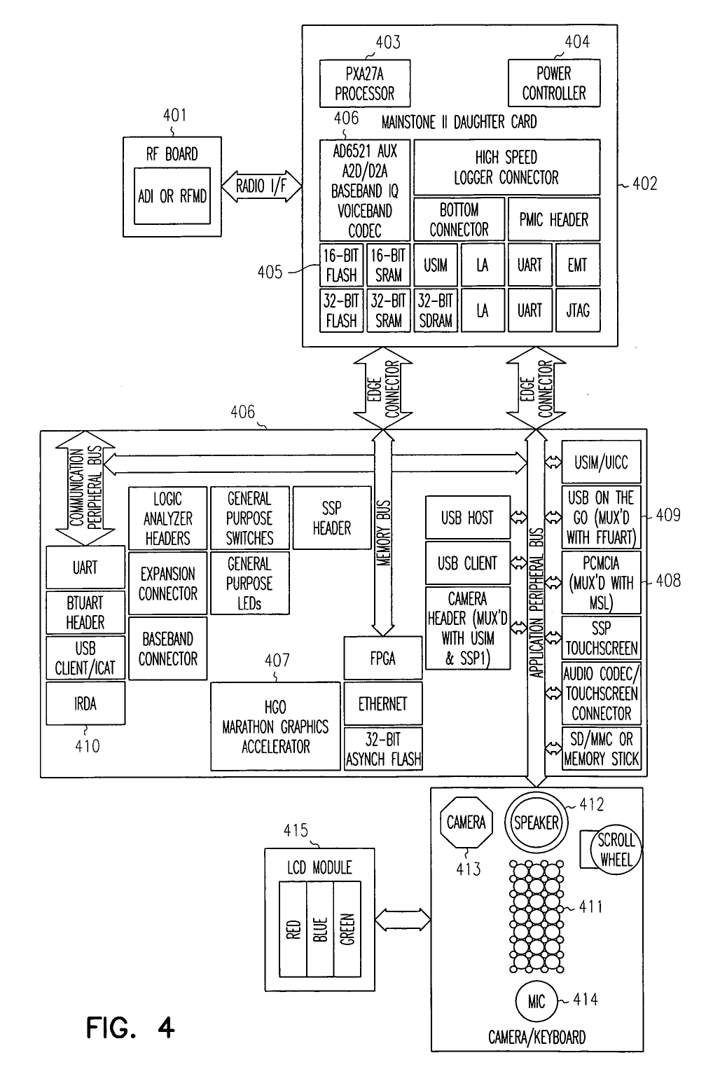

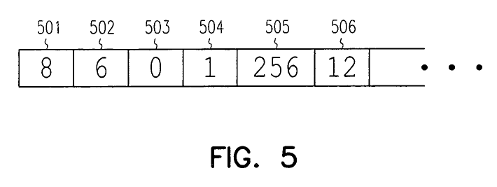

FIG. 4 shows a more detailed block diagram of a cellular telephone, consistent with an example embodiment of the invention. The cellular phone has an RF board 401 that is operable to receive and transmit radio frequency data, and to communicate with cellular telephone towers or base stations. The RF board is coupled to a processor board 402, which has a processor 403, a power controller 404, memory 405, and a voice data coder/decoder (CODEC) 406. The processor executes instructions loaded into system memory from the flash nonvolatile memory 405 to perform various cellular telephone functions such as placing or receiving calls, managing a phone directory, and managing sounds and images such as ringtones and images taken with an onboard camera.

A system board 406 is coupled to the processor board, and provides interfaces from the processor to a variety of components such as a graphics processor 407, PCMCIA (Personal Computer Memory Card International Association format) port 408 and USB (Universal Serial Bus) port 409, and IRDA (Infrared Data Association) port 410. The system board 406's peripheral bus also couples the processor to user interface devices, such as keypad 411, speaker 412, camera 413, and microphone 414. A video display 415 is also coupled to the graphics processor 407 and to the processor 403, and is operable to display color graphics through its red, green, and blue liquid crystal display (LCD) elements.

In operation, the processor 403 executes software instructions loaded into the system memory from nonvolatile memory 405, and operates in a power mode managed by power controller 404. The processor oversees receiving and sending voice data compressed via voice codec 406 and other data via the RF module 401, and controls other functions of the phone, such as directory functions, operation of the camera 413, selection of ringtones, and interaction with other devices or peripherals via interfaces such as IRDA port 410, USB port 409, and PCMCIA interface 408.

When the processor is inactive, such as when no instructions are being executed to perform functions such as those described above, the processor's digital logic circuits and other circuits within the cellular phone can be made inactive to save power. In some embodiments, this comprises reducing the voltage supplied to the digital logic circuits to a nonzero but lower-than-normal operating voltage. This is performed by methods such as those previously described, and as shown in FIGS. 2 and 3, and enables the digital logic circuits with a reduced voltage power signal to retain their states, even though they are not fully operational or able to reliably change state in the reduced voltage power mode.

For example, consider a mode where the cellular phone is on and fully operational, but the user has not performed any action and the cell phone is not actively executing processor instructions. The power controller in this example first reduces the clock frequency of the processor to reduce the number of state transitions made by transistors within the processor to conserve power. After a few seconds of inactivity, the power controller makes the processor inactive, and reduces the voltage supplied to the processor. The processor retains its internal state, but is unable to process software instructions or perform other functions until brought out of the low power mode. Voltage is increased and the processor is brought out of the low power mode when triggered by a hardware event, such as a timer, actuation of a user input such as keyboard 411 or a scroll wheel, or receipt of an incoming phone call. In further embodiments, other circuits such as the graphics processor 407 and interface controllers such as USB controller 409 are operated under the control of the power manager, and are supplied a reduced voltage power signal when in a reduced or low power level or mode

In some embodiments, the power controller's control over the circuitry in the electronic device is configurable via software, such as via an application programming interface (API) and via registers in the power controller. This is illustrated in FIG. 5, which shows a register structure consistent with an example embodiment of the invention. Bit locations 501 and 502 are oscillator multiplier bits, such that the clock frequency provided to the digital logic circuits under management is multiplied by the bit values in register location 501, and by twice the bit value in register location 502. In the example shown, the base oscillator frequency of 5 MHz is multiplied by 8 based on the value of the bits in register 501, and is further multiplied by 12 based on twice the value of the bits in register location 502. The resulting clock frequency is therefore 480 MHz. Bit location 503 is the alternate memory controller clock bit, which if set to a one value results in a clock that is automatically set to the same as the memory controller's clock frequency, to conserve power while waiting form data to be provided from memory.

Voltage change register 504 indicates whether a voltage change is to take place, and in a further embodiment is accompanied by read pointer data at 505 indicating a register or memory location containing commands to be processes to execute the voltage change. In embodiments where the voltage change is delayed, delay command execution register 506 stores bits indicating a delay in clock cycles from the time a voltage change is signaled to the time execution of the voltage change commands identified by the read pointer 505 are executed. Further embodiments include registers identifying voltage levels, linking voltage changes with frequency changes, and other such variations on the examples presented here.

The power modes in the various examples discuss transition from a high power mode to a low power mode and from a low power mode to a high power mode, which in some embodiments are transitions between two of many different power modes. In a specific cellular phone example, a normal mode, idle mode, deep idle mode, standby mode, sleep mode, and deep sleep mode are all supported by the power management controller. Normal mode is a mode in which all internal power domains and external power supplies are fully powered and functional, and the processor clock is running at a normal speed. In idle mode, the clocks to the CPU are disabled or substantially reduced in frequency, and the clock is restarted or brought back to a substantially higher speed through a hardware control signal such as a hardware interrupt. Deep idle mode is entered only after the processor's core frequency has been set to a frequency substantially lower than its normal operating frequency, and CPU clocks are disabled until resumption is triggered by a hardware event.

Standby mode further involves placing all internal power domains other than clock and oscillator signals into a low power mode where state is retained but no activity is allowed. The clock source is in some further embodiments disabled, and internal or external events such as actuation of a button trigger a wake-up to a higher power mode. The low power mode in which state is retained in some embodiments includes reduction of a voltage supplied to the circuit under control to a voltage level lower than operating voltage, but higher than a zero voltage level. The voltage level is sufficient to keep the transistors of the logic circuits in their present states, but not sufficient to enable full operation of the digital logic circuits.

In sleep mode, the power domains internal to the processor other than clock and oscillator circuits used by the power manager and real time clock are powered off, and only select external domains are retained in a low voltage mode in which their states are retained. Because core elements of the processor such as the pipeline, registers, and program counter are invalid after being powered down completely, resuming operation requires rebooting the cellular phone.

A further low power mode known as deep sleep mode is also employed in a further embodiment, which is essentially the same as sleep mode but in which the cell phone's states are maintained by the backup battery rather than by the main system battery or external power source. This mode is used, for example, when the phone is programmed and packaged for delivery to the end user, and may not have a main system battery attached.

These modes serve to illustrate how various logic circuit elements, whether internal or external to the processor, can be powered with a reduced voltage power signal. In some example embodiments, the reduced voltage allows the digital logic circuit to retain its present state, but does not permit change of state or operations such as execution of software instructions when at a reduced voltage.

The reduction in voltage of the power signal results in power savings greater than can be achieved by simply leaving an inactive circuit fully powered, and retention of the logic states in a reduced voltage logic circuit facilitate rapid resumption of operation, making use of a low voltage mode for brief periods of time a desirable mode of power conservation even in environments where responsiveness to external stimulus and rapid resumption of normal operations is desired.

Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the example embodiments of the invention described herein. It is intended that this invention be limited only by the claims, and the full scope of equivalents thereof.

1. An apparatus, comprising:
at least one digital logic circuit; and
a power control circuit operable to reduce a power signal voltage applied to the at least one digital logic circuit, operable to change the digital logic circuit from a high power mode into a low power mode, and operable to increase the voltage of the power signal applied to the digital logic circuit before changing the digital logic circuit from a low power level to a high power level.

2. The apparatus of claim 1, wherein the power control circuit is operable to execute a command to reduce the voltage of the power signal applied to the digital logic circuit a specific period of time after receiving the command.

3. The apparatus of claim 1, wherein changing the digital logic circuit from a low power mode to a high power mode is triggered by a hardware event external to the at least one digital logic circuit and power control circuit.

4. The apparatus of claim 1, wherein the power control circuit receives instructions to control the power level of the at least one digital logic circuit via register settings.

5. The apparatus of claim 1, wherein the power control circuit receives instructions to control the power mode of the at least one digital logic circuit via a software application programming interface (API).

6. The apparatus of claim 1, wherein the power control circuit is operable to vary the power mode of the at least one digital logic circuit through at least three different power levels.

7. The apparatus of claim 1, wherein the power control circuit is further operable to change the digital logic circuit from a high power level to a low power level and from a low power level to a high power level independent of any change to the voltage of the power signal applied to the at least one digital logic circuit

8. A method of controlling power consumption in a computerized electronic system, comprising:
reducing the voltage of a power signal applied to at least one digital logic circuit,
changing the digital logic circuit from a high power level to a low power level; and
changing the voltage of the power signal applied to the digital logic circuit before bringing the digital logic circuit from a low power level to a high power level.

9. The method of controlling power consumption in a computerized electronic system of claim 8, wherein the computerized electronic system is a battery-powered portable electronic device.

10. The method of controlling power consumption in a computerized electronic system of claim 8, wherein reducing the voltage of a power signal applied to at least one digital logic circuit comprises executing a command to reduce the voltage of the power signal applied to the at least one digital logic circuit a specific period of time after receiving the command.

11. The method of controlling power consumption in a computerized electronic system of claim 8, wherein bringing the at least one digital logic circuit from a low power level to a high power level is triggered by a hardware event external to the computer processor and power control circuit.

12. The method of controlling power consumption in a computerized electronic system of claim 8, wherein the power level of the at least one digital logic circuit is changeable by changing register settings.

13. The method of controlling power consumption in a computerized electronic system of claim 8, wherein the power level of the at least one digital logic circuit is changeable via a software application programming interface (API).

14. The method of controlling power consumption in a computerized electronic system of claim 8, wherein the power level of the computer processor circuit is variable through at least three different power levels.

15. The method of controlling power consumption in a computerized electronic system of claim 8, wherein changing the digital logic circuit from a high power level to a low power level and from a low power level to a high power level occurs independent of any change in the voltage of the power signal applied to the at least one digital logic circuit

16. A system comprising:
at least one digital logic circuit;
a battery coupled to power the at least one digital logic circuit; and
a power control circuit operable to reduce the voltage of a power signal applied to the at least one digital logic circuit, operable to change the digital logic circuit from a high power level to a low power level, and operable to increase the voltage of the power signal applied to the at least one digital logic circuit before bringing the digital at least one digital logic circuit from a low power level to a high power level.

17. The system of claim 16, wherein the power control circuit is operable to execute a command to reduce the voltage of the power signal applied to the digital logic circuit a specific period of time after receiving the command.

18. The system of claim 16, wherein changing the at least one digital logic circuit from a low power level to a high power level is triggered by a hardware event external to the computer processor and power control circuit.

19. The system of claim 16, wherein the power control circuit receives instructions to control the power mode of the at least one digital logic circuit via register settings.

20. The system of claim 16, wherein the power control circuit receives instructions to control the power mode of the at least one digital logic circuit via a software application programming interface (API).

21. The system of claim 16, wherein the power control circuit is operable to vary the power level of the at least one digital logic circuit through at least three different power levels.

22. The system of claim 16, wherein the power control circuit is further operable to change the digital logic circuit from a high power level to a low power level and from a low power level to a high power level independent of any change in the voltage of the power signal applied to the digital logic circuit

23. A power controller comprising:
a voltage control module operable to reduce the voltage of a power signal applied to at least one digital logic circuit, and
a memory operable to store power control information; and
a processor module operable change the digital logic circuit from a high power level to a low power level and to decrease the voltage of the power signal supplied to the at least one digital logic circuit, and further operable to increase the voltage of the power signal applied to the at least one digital logic circuit via the voltage control module before changing the digital logic circuit from a low power level to a high power level.

24. The power controller of claim 23, wherein the power controller processor module is operable to execute a command to reduce the voltage of the power signal applied to the digital logic circuit a specific period of time after receiving the command.

25. The power controller of claim 23, wherein changing the digital logic circuit from a low power level to a high power level is triggered by a hardware event external to the power control circuit and the at least one digital logic circuit.

26. The power controller of claim 23, wherein the power controller memory comprises at least one register, and the power controller receives instructions to control the power level of the at least one digital logic circuit via at least one register setting.

27. The power controller of claim 23, wherein the power controller receives instructions to control the power mode of the at least one digital logic circuit via a software application programming interface (API).

28. The power controller of claim 23, wherein the power controller is operable to vary the power mode of the digital logic circuit through at least three different power levels.

29. The power controller of claim 23, wherein the power controller is further operable to bring the digital logic circuit from a high power level to a low power level and from a low power level to a high power level independent of any change in the voltage of the power signal applied to the at least one digital logic circuit

30. The power controller of claim 23, wherein the power controller comprises an integrated circuit.
